(19) United States
(12) Patent Application Publication
(10) Pub. No.: US 2019/0221083 A1
(43) Pub. Date: Jul. 18, 2019

(54) WIRELESS BEACON TRACKING SYSTEM FOR MERCHANDISE SECURITY

(71) Applicant: InVue Security Products Inc., Charlotte, NC (US)

(72) Inventors: Jeffrey A. Grant, Charlotte, NC (US); Gary A. Taylor, Fort Mill, SC (US); Troy Prothero, Charlotte, NC (US); Jonathon D. Phillips, Fort Mill, SC (US); James Richard Terrell, II, Charlotte, NC (US); Jesse Gately, Charlotte, NC (US); Christopher J. Fawcett, Charlotte, NC (US)

(21) Appl. No.: 16/361,347

(22) Filed: Mar. 22, 2019

Related U.S. Application Data
(63) Continuation-in-part of application No. 15/428,707, filed on Feb. 9, 2017.
Application No. 15/428,707 is a continuation of application No. PCT/US2016/030722, filed on May 4, 2016.
(60) Provisional application No. 62/157,125, filed on May 5, 2015.
(60) Provisional application No. 62/198,163, filed on Jul. 29, 2015.
(60) Provisional application No. 62/293,806, filed on Feb. 11, 2016.
(60) Provisional application No. 62/685,556, filed on Jun. 15, 2018.
(60) Provisional application No. 62/647,200, filed on Mar. 23, 2018.

(51) Int. Cl. G08B 3/10; H04W 4/029; H04W 4/02; H04W 80/02; H04W 40/24

(52) U.S. Cl. CPC G08B 3/1016; H04W 4/029; H04W 40/244; H04W 80/02; H04W 4/023

(57) ABSTRACT

Embodiments of the present invention are directed to merchandise security systems and methods for displaying and protecting items of merchandise from theft. A merchandise security system and method according to the invention includes at least one wireless-enabled computing device having a unique media access control (MAC) address and a wireless beacon tracking system including a plurality of nodes positioned within a display area. The plurality of nodes are operable for obtaining the MAC address and signal strength of the wireless-enabled computing device and for determining a location of the wireless-enabled computing device. The wireless beacon tracking system further includes a server operably associated with the plurality of nodes for providing a notification relating to a change in the location of the wireless-enabled computing device relative to a home location.

### CROSS REFERENCE TO RELATED APPLICATIONS

The present application is a continuation-in-part of U.S. application Ser. No. 15/428,707, filed Feb. 9, 2017, which is a continuation of International Application No. PCT/US2016/030722, filed May 4, 2016, which claims the benefit of U.S. Provisional Application No. 62/157,125, filed May 5, 2015, U.S. Provisional Application No. 62/198,163, filed Jul. 29, 2015, and U.S. Provisional Application No. 62/293,806, filed Feb. 11, 2016, the contents of which are each incorporated by reference herein in their entirety. The present application is also a non-provisional of and claims the benefit of U.S. Provisional Application No. 62/685,556, filed on Jun. 15, 2018 and U.S. Provisional Application No. 62/647,200, filed on Mar. 23, 2018, the contents of which are each incorporated by reference herein in their entirety.

### FIELD OF THE INVENTION

Embodiments of the present invention relate generally to security devices, systems, and methods for displaying an item of merchandise and for protecting the item of merchandise from theft. More particularly, embodiments of the invention relate to a wireless beacon tracking system for merchandise security.

### BACKGROUND OF THE INVENTION

Retailers routinely display electronic items of merchandise in an open display area for customers to examine and interact with while making a decision whether to purchase the item. The value of the item, however, makes it an attractive target for a shoplifter. In some instances, the item is secured on a merchandise security device, such as a merchandise display stand, to prevent or at least deter theft of the item. The merchandise security device may include an alarm for indicating that the item of merchandise has been separated from the security device. The presence of a merchandise security device, however, can inhibit the ability of the customer to interact with the merchandise, and thus, detract from the customer experience. It is therefore desirable in some instances to display the item of merchandise without the item being attached or tethered to a merchandise security device. Portable computing devices, such as mobile telephones (e.g., Smartphone), personal computers (e.g., tablet, laptop, etc.), wearable wireless devices (e.g., GALAXY WEAR™, APPLE WATCH™, etc.) and digital cameras, are examples of items of merchandise that a retailer may prefer to display without the item being attached or tethered to a merchandise security device so as to enhance the customer experience.

On the other hand, displaying a relatively expensive electronic item of merchandise without an alarming merchandise security device increases the risk that the item may be misplaced or stolen. For example, a shoplifter may pretend to examine the item in the display area and then leave the display area with the item while the sales associate is distracted. The shoplifter can then attempt to exit the retail store with the item of merchandise.

### BRIEF SUMMARY

Embodiments of the present invention are directed to merchandise security systems and methods for displaying and protecting items of merchandise (e.g., computing devices) from theft. In one embodiment, a merchandise security system includes at least one wireless-enabled computing device having a unique media access control (MAC) address and a wireless beacon tracking system comprising a plurality of nodes positioned within a display area. The plurality of nodes being are configured to obtain the MAC address and a signal strength of the wireless-enabled computing device for determining a location of the wireless-enabled computing device, the wireless beacon tracking system further comprising a server operably associated with the plurality of nodes for providing a notification relating to a change in the location of the wireless-enabled computing device relative to a home location.

In another embodiment, a method includes using each of a plurality of nodes positioned within a display area for displaying the wireless-enabled computing device to obtain the unique MAC address and a signal strength of the wireless-enabled computing device and for determining a location of the wireless-enabled computing device. The method further includes using a server operably associated with the plurality of nodes to provide a notification relating to the location of the wireless-enabled computing device relative to a home location.

In one embodiment, a method includes obtaining a unique MAC address of a wireless-enabled computing device and a signal strength using a plurality of nodes positioned within a display area for displaying the wireless-enabled computing device. The method also includes determining a location of the wireless-enabled computing device and providing a notification with a server operably associated with the plurality of nodes relating to the location of the wireless-enabled computing device relative to a home location.

In another embodiment, a merchandise security system includes a plurality of tags, one or more of the tags configured to be attached to a respective one of a plurality of computing devices and to detect unauthorized removal of the tag from the computing device. The merchandise security system also includes a plurality of nodes positioned within a display area, the plurality of nodes configured to wirelessly communicate with each of the tags for determining a location of the computing devices. In addition, the merchandise security system includes a server in communication with the plurality of nodes for tracking the location of the computing devices within the display area.

In another embodiment, a method includes attaching one or more of a plurality of tags to a respective one of a plurality of items of merchandise and using a plurality of nodes located within a display area to wirelessly communicate with each of the tags for determining a location of the items of merchandise. The method further includes using a server in communication with the plurality of nodes to determine a location of the items of merchandise within the display area and to determine whether to initiate an alarm signal.

In one embodiment, a method includes transmitting a signal with a tag attached to an item of merchandise and receiving the signal at one or more of a plurality of nodes positioned within a display area for displaying the item of merchandise. The method also includes determining a location of the item of merchandise and initiating an alarm signal in response to unauthorized removal of a tag from the item of merchandise.

In another embodiment, a merchandise security system includes at least one wireless-enabled device (e.g., a tag or a computing device) and a wireless beacon tracking system comprising a plurality of nodes positioned within a display area. The plurality of nodes are configured to communicate with the at least one wireless-enabled device for determining a location of the wireless-enabled device. In addition, the wireless beacon tracking system further includes a server operably associated with the plurality of nodes for providing a notification relating to a change in the location of the wireless-enabled device relative to a home location.

In another embodiment, a wireless tracking system for tracking wireless-enabled computing devices is provided. The wireless tracking system includes at least one wireless-enabled computing device having a unique media access control (MAC) address and a wireless tracking system comprising a plurality of nodes positioned within a display area (e.g., a display area in a retail store). The plurality of nodes are configured to obtain the MAC address of the wireless-enabled computing device for determining a location of the wireless-enabled computing device. In some cases, the wireless tracking system further includes a server operably associated with the plurality of nodes for recording the MAC address.

In another embodiment, a method for tracking wireless-enabled computing devices is provided, wherein the wireless-enabled computing devices each have a unique media access control (MAC) address. The method includes obtaining a MAC address of at least one wireless-enabled computing device using a plurality of nodes positioned within a display area, determining a location of the at least one wireless-enabled computing device. In some cases, the method further includes recording the MAC address.

In another embodiment, a wireless tracking system includes a plurality of wireless-enabled computing devices and a plurality of nodes positioned within a display area. The plurality of nodes being configured to communicate with the plurality of wireless-enabled computing devices for determining a unique identifier associated with each of the plurality of wireless-enabled computing devices.

### BRIEF DESCRIPTION OF THE DRAWINGS

FIG. 1 is schematic of a plurality of computing devices according to one embodiment of the present invention.

FIG. 2 is schematic of a merchandise security system according to one embodiment of the present invention.

FIG. 3 is a schematic illustrating a plurality of computing devices within a retail store of the merchandise security system of FIG. 2.

FIG. 4 is a schematic illustrating a plurality of computing devices that have moved within the retail store of the merchandise security system of FIG. 2.

FIG. 5 is a schematic illustrating a plurality of annunciators located within the retail store of the merchandise security system of FIG. 2.

FIG. 6 is schematic illustrating an annunciator of FIG. 5 providing a notification where a computing device has been moved a greater distance from a home location than an allowable distance, but less than an unacceptable distance.

FIG. 7 is schematic illustrating another annunciator of FIG. 5 providing a notification where a computing device has been moved a greater distance from a home location than an allowable distance, but less than an unacceptable distance.

FIG. 8 is schematic illustrating another annunciator of FIG. 5 providing a notification where a computing device has been moved a greater distance from a home location than an allowable distance, but less than an unacceptable distance.

FIG. 9 is schematic illustrating another annunciator of FIG. 5 providing a notification where a computing device has been moved a distance greater than an unacceptable distance.

FIG. 10 is a schematic illustrating a tag attached to a portable computing device according to one embodiment of the present invention.

FIG. 11 is a schematic of a wireless tracking system according to one embodiment of the present invention.

FIG. 12 is a schematic illustrating a plurality of computing devices within a retail store of the wireless tracking system of FIG. 11.

FIG. 13 is a schematic illustrating a plurality of computing devices that have moved within the retail store of the wireless tracking system of FIG. 11.

### DETAILED DESCRIPTION OF EMBODIMENTS OF THE INVENTION

Referring now to the accompanying drawing figures wherein like reference numerals denote like elements throughout the various views, one or more embodiments of a merchandise security system and a wireless tracking system for identifying and tracking computing devices (e.g., items of merchandise), such as to protect items of merchandise from theft, are shown. Embodiments of the present invention include a merchandise security system and method that utilize wireless beacon tracking to determine the location of one or more items of merchandise. A merchandise security system and method according to embodiments of the invention are operable for use with portable computing devices, such as mobile telephones (e.g., Smartphone), personal computers (e.g., tablet, laptop, etc.), wearable wireless devices (e.g., GALAXY WEAR™, APPLE WATCH™, etc.) and digital cameras, as well as a variety of other types of devices, such as keys, safers or lock boxes, and cable wraps. In the embodiments shown and described herein, a merchandise security system, indicated generally at 10, is provided for displaying portable computing devices, indicated generally at 12, and protecting the wireless-enabled computing devices from theft. Merchandise security system 10 utilizes a wireless beacon tracking system, indicated generally at 20, to track the position of each of the computing devices 12. In some embodiments, the computing devices 12 are wireless enabled, and each of the wireless-enabled computing devices are Wi-Fi enabled and do not require any additional software application for use with the wireless beacon tracking system 20. Although some of the embodiments are discussed in the context of a retail store, it is understood that the embodiments disclosed herein are applicable to any number of business or residential sectors, such as restaurants, hospitals, amusement parks, etc.

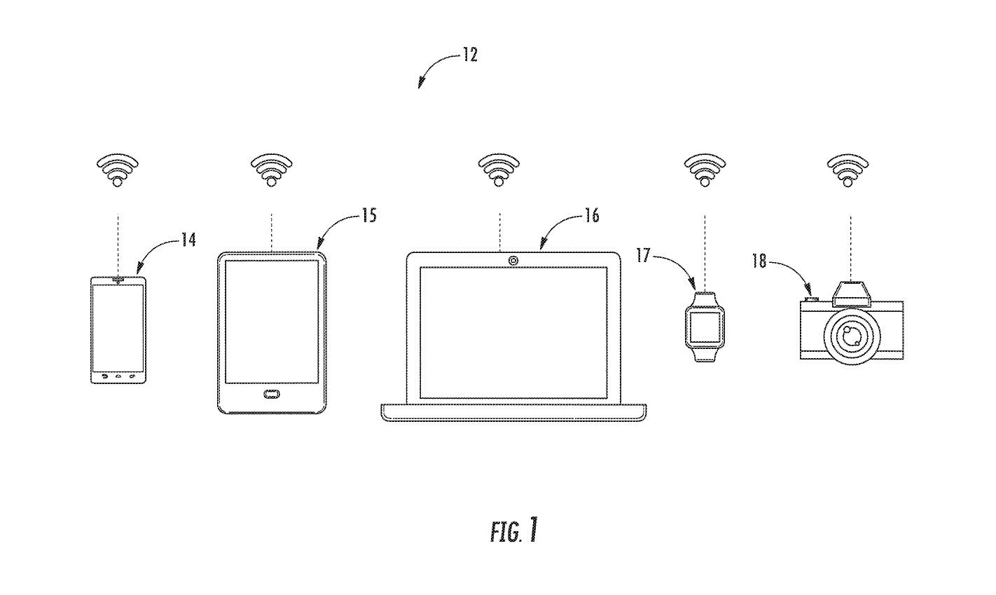

Portable computing devices of the type that may be displayed and protected by a merchandise security system 10 according to an exemplary embodiment of the invention are illustrated in FIG. 1. By way of example and not limitation, the portable computing devices 12 may include an active handheld handset or mobile telephone, such as a Smartphone 14, an active personal computer, such as a tablet 15 or laptop 16, an active wearable wireless device 17, and/or an active digital camera 18. As used herein, the term “active” is intended to mean that the portable computing device 12 is powered on and is equipped with a network adapter having a unique identifier commonly known as a media access control (MAC) address.

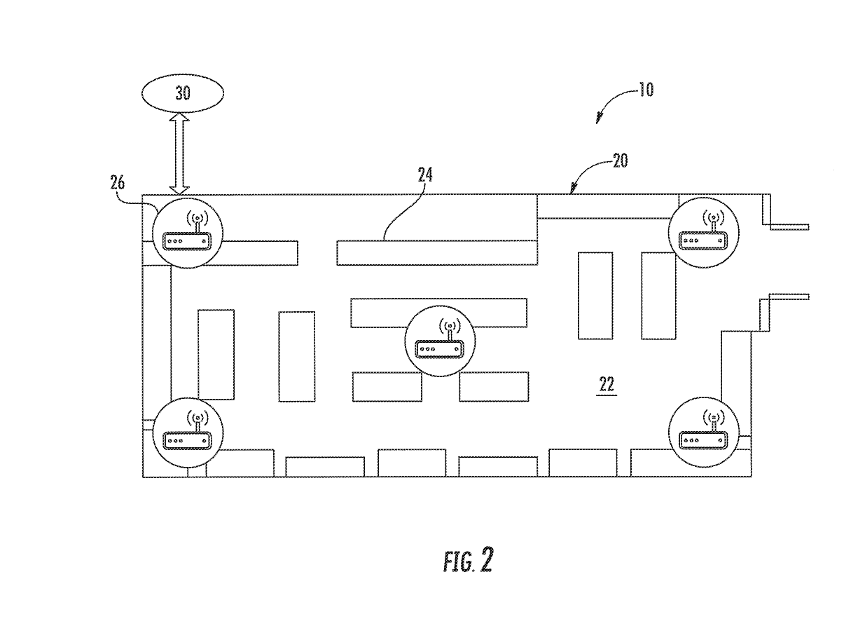

FIG. 2 illustrates a wireless beacon tracking system 20 according to an exemplary embodiment of the present invention provided in an open display area 22, such as a merchandise display area of a retail store, for displaying and protecting wireless-enabled computing devices 12. As used herein, the term “open” is intended to mean that a customer may move about within the display area 22 without passing through a security checkpoint or gateway that detects a security signal transmitted or emitted by a tag 34 attached to the wireless-enabled computing device 12. The wireless beacon tracking system 20 may include a custom floor plan in an retail environment. The display area 22 may include a number of display surfaces 24, such as a table, shelf, countertop, or the like, for supporting one or more wireless-enabled computing devices 12. Typically, several wireless-enabled computing devices 12 of the same type or different types are supported on each display surface 24. The wireless-enabled computing devices 12 are supported on a display surface 24 without the device being attached or tethered to a merchandise security device. As a result, a customer may examine and freely interact with the wireless-enabled computing device 12 in a manner that enhances the customer experience, and thereby increases the likelihood that the customer will make a decision to purchase the device. Typically, the customer purchases the wireless-enabled computing device 12 from the inventory of the retailer with the assistance of a sales associate. However, it is understood that each of the computing devices 12 may be tethered to the display surface 24 or security device in other embodiments.

The wireless beacon tracking system 20 comprises a plurality of nodes 26 that are positioned at predetermined locations within the display area 22. By way of example and not limitation, a plurality of nodes 26 may be positioned around the perimeter of the display area 22 and at least one node may be positioned at about the center of the display area, as illustrated in FIG. 2. Regardless, each node 26 is operable for detecting one or more active wireless-enabled computing devices 12, and for periodically obtaining a MAC address and a signal strength of each of the devices detected by the node. In some cases, the signal strength may be a strength of a Wi-Fi signal, although other wireless signals may be used for this purpose (e.g., Bluetooth). The wireless beacon tracking system 20 further comprises a server 33 operable for communicating with each of the nodes 26 to determine the location of a wireless-enabled computing device 12 relative to the nodes. By way of example and not limitation, the server 30 may determine the location of the wireless-enabled computing device 12 by means of triangulation utilizing at some of the nodes 26. In some cases, the server 30 may be a cloud-based server on a public or private network for receiving and analyzing various information received from the nodes 26 and/or tags 34.

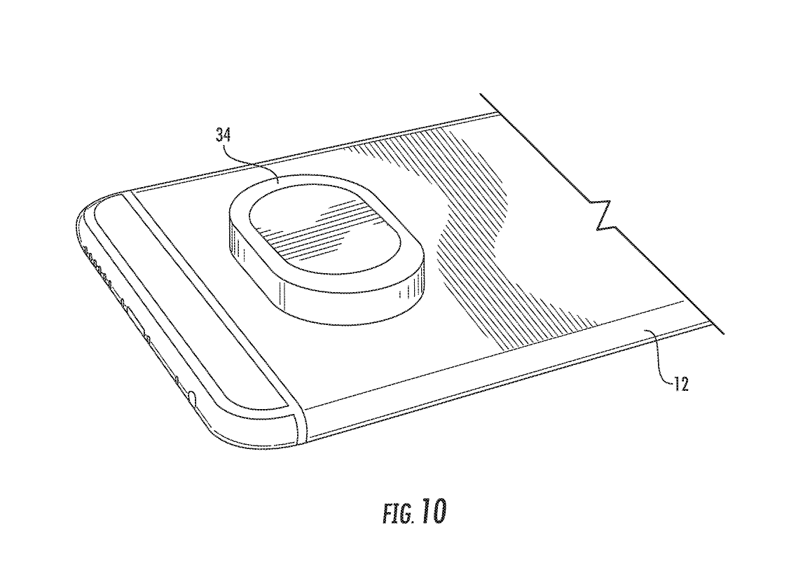

In one embodiment, the merchandise security system 10 further includes a plurality of tags 34, wherein each tag may be, for example, any wireless-enabled device. In one embodiment, FIG. 10 shows that one tag 34 is attached to a respective computing device 12, although more than one tag can be attached to a computing device, or any other item of merchandise, if desired. The tags 34 may be coupled to computing devices 12 using any suitable technique, such as with an adhesive, cables, and the like. In some cases, the tag 34 may be removable and reusable. In addition, a tag 34 may include a variety of components. For example, the tags 34 and/or nodes 26 may include a communication system for communicating with one another. For instance, the communication system may be configured for wireless communication using any desired communications protocol, such as Bluetooth communication, Bluetooth low energy communication, WiFi, cellular, received signal strength indicator (“RSSI”), ultra-wideband (UWB) and/or ambient backscatter. The communication system may include an antenna for carrying out such communication. In some embodiments, the tags 34 and/or nodes 26 may be configured to communicate with one another via respective communication systems. For example, the tags 32 may communicate with one another to transmit or relay signals to node(s) 26 and/or the server 30. Thus, the tags 34 may be configured to communicate with one another and other components within the system 10. In some cases, the communication between the tags 34 and nodes 26 may be one way, although two-way communication may be employed in other embodiments.

It is understood that the tag 34 may have any desired size and configuration suitable for attachment to a computing device 12. For example, the tag 34 may include a housing with a low profile that does not take away from the presentation of the computing device 12. In some embodiments, the tags 34 are reusable such that the tags may be removed by a sales associate or at a checkout counter and reused on another computing device 12. In the case where the tag 34 includes a battery 38, the battery may be rechargeable. In some embodiments, the tag 34 may be configured to be integrated with the computer device 12. For example, the tag 34 may be disposed within the computing device 12 itself. The computing device 12 may include a removable battery, and the tag 34 may be configured to be disposed within the battery compartment of the computing device. In this instance, the tag 34 itself may provide power to the computing device 12, or a smaller battery may be used in the computing device along with the tag 34. In other embodiments, the tag 34 may include a sensing device, such as a pressure or plunger switch, that is configured to detect the computing device 12. In this regard, the sensing device may be configured to detect unauthorized removal of the tag 34 in response to actuation of the sensing device, which could in turn affect the communications system of the tag (e.g., stopping transmission of a signal from the tag). In some embodiments, the tag 34 may include similar functionality as that disclosed in International Publication No. WO 2015/050710, entitled System and Method for Monitoring Merchandise in a Retail Environment, the contents of which are incorporated by reference in its entirety herein.

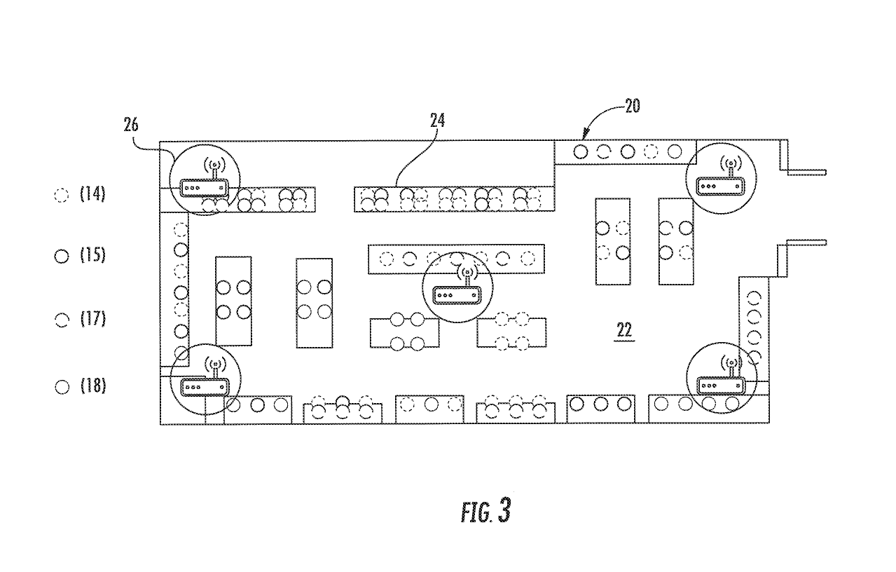

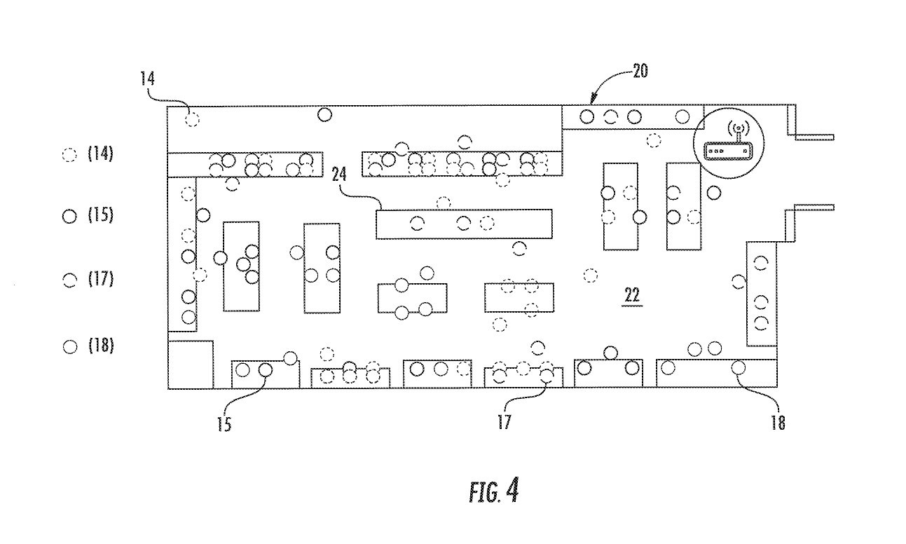

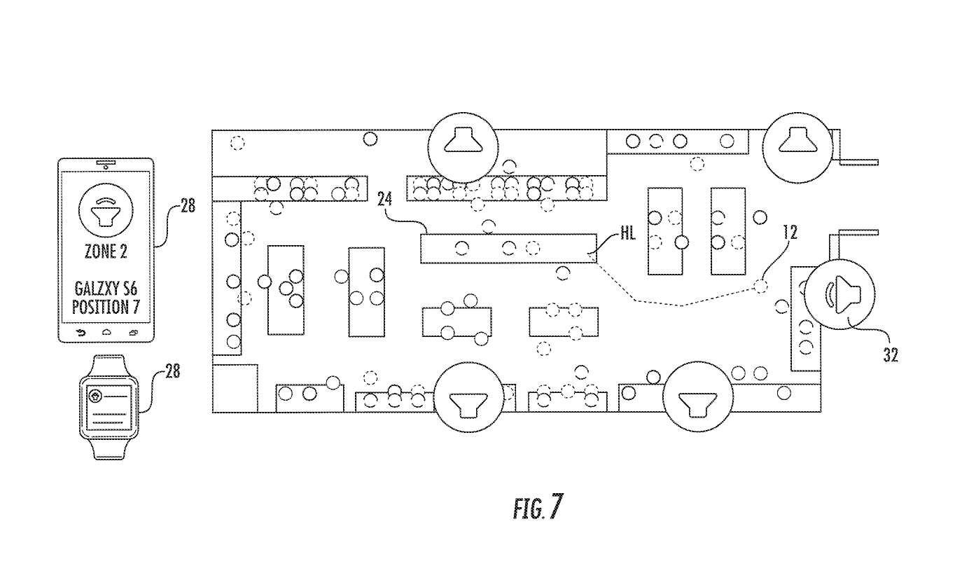

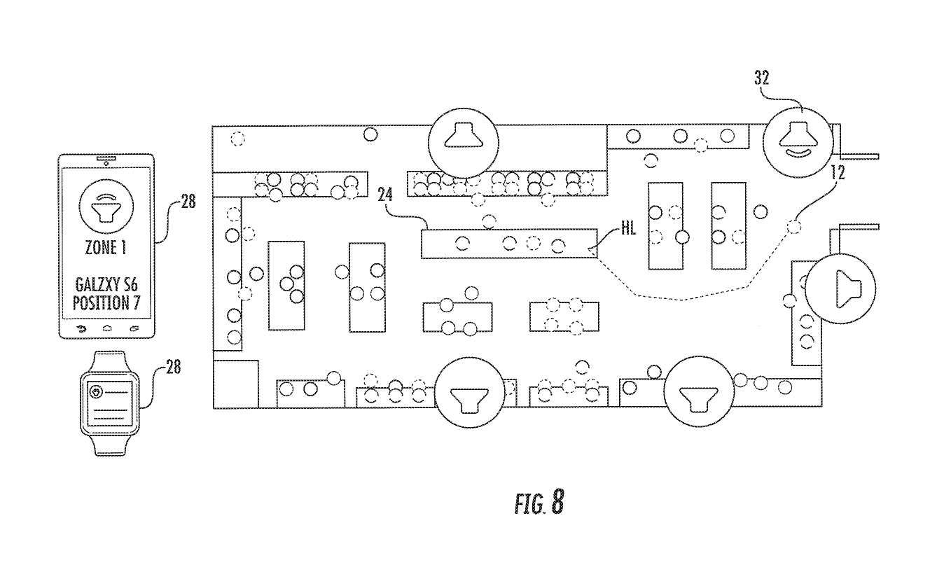

FIGS. 3-9 illustrate exemplary embodiments of a merchandise security system 10 that utilizes a wireless beacon tracking system 20 according to the present invention. FIG. 3 shows a plurality of wireless-enabled computing devices 12 comprising handheld handsets 14, tablets 15, wearable wireless devices 17, and digital cameras 18 located on display surfaces 24 within an open display area 22 of a retail store. The wireless-enabled computing devices 12 may be located at positions recognized by one or more nodes 26. At least some of the wireless-enabled computing devices 12 may not be attached or tethered to a merchandise security device, such as an alarming merchandise security stand. Each of the wireless-enabled computing devices 12 to be displayed and protected by the wireless beacon tracking system 20 comprises an internal network adapter having a MAC address. As previously described, the wireless beacon tracking system 20 of the merchandise security system 10 comprises a plurality of nodes 26 positioned within the display area 22 in a predetermined grid pattern. As shown in FIG. 3, the wireless beacon tracking system 20 comprises five nodes 26 with one of the nodes positioned at each of the four corners of the display area 22 and the remaining node positioned at the center of the display area. In one embodiment, a center node 26 may be used as a controlling node that is able to communicate with the other nodes to determine the signal strength of one or more devices 12. For example, the center node 26 may receive signals from each of the other nodes and determine the nodes with the strongest detected signal strength of the device 12 (e.g., two other nodes with the strongest detected signal strength). Using the nodes 26 detecting the strongest signal strength of the device 12, the server 30 can receive this information for determining the position of the device. In some cases, the position of the devices 12 may be tracked in real time. The center node 26 may communicate directly with the server 30 and/or remote devices 28 for providing information regarding one or more devices 12.

In one embodiment, each of the computing devices 12 to be displayed and protected by the wireless beacon tracking system 20 comprises a tag 34. Each tag 34 may be configured to transmit a signal that is detectable by at least one of the nodes 26. For example, the center node 26 may receive signals from one or more tags 34 having a stronger signal strength than the remaining nodes due to the closer proximity of the tags to the center node. Using the nodes 26 detecting the strongest signal strength of the tag 34, the server 30 can receive this information for determining the position of the device. The nodes 26 may communicate directly with the server 30 for providing information regarding one or more devices 12.

Each of the wireless-enabled computing devices 12 may be registered with a server 30, such as a cloud-based server on a public or private network. For example, for each device 12 on display in the display area, the MAC address will be known and can be registered at a central location with the server 30. In one embodiment, the server 30 may be a central control device 28 on a local area network. The server 30 may, for example, be a personal computer, such as a desktop, laptop, tablet or notebook computer, a mobile telephone, such as a Smartphone, or a wearable wireless device. In some embodiments, the server 30 may communicate with one or more remote devices 28. Each remote device 28 may be located at any desired location, such as remote from the wireless beacon tracking system 20 where an authorized user or administrator can manage and track the wireless-enabled computing devices 12. In some cases, the user may log into an administrative online dashboard and define various levels of the location of the wireless-enabled computing devices 12, upload floor plans or a map for each level, and/or mark the placement of each node on the floor plan or map of each level. In other cases, remote devices 28 may be provided to sales associates located within or near the display area 22 for receiving various notifications and information from the server 30 and/or other remote devices. In one embodiment, the server 30 may include software that enables an authorized user to visually track the location of the devices 12, such as on a map.

In another embodiment, each of the computing devices 12 and/or tags 34 may be registered with a server 30. For example, for each device 12 on display in the display area can be associated with a specific tag 34 and can be registered at a central location with the server 30. In some embodiments, the server 30 may communicate with one or more nodes 26. Each node 26 may be located at any desired location within the wireless beacon tracking system 20 where an authorized user or administrator can manage and track the computing devices 12. In one embodiment, the server 30 may include software that enables an authorized user to visually track the location of the computing devices 12 and/or tags 34, such as on a map, in real time.

The nodes 26 of the wireless beacon tracking system 20 are operable for acquiring, or obtaining, the MAC address of each of the wireless-enabled computing devices 12 being displayed and protected by the system. The initial location, also referred to herein as the “home location” HL, of each of the wireless-enabled computing devices 12 may be determined by triangulating the MAC address of the address from at least three (3) of the nodes 26. Thereafter, the nodes 26 may periodically obtain the MAC addresses of the wireless-enabled computing devices 12, determine the updated locations of the devices 12, and upload the updated locations of the devices 12 to the server 30 and/or the remote device 28. In the event that a device 12 has moved from the home location, the server 30, the nodes 26, and/or the remote device 28 provide a suitable output to an administrator of the merchandise security system 10, for example a sales associate assigned to the display area 22.

In another embodiment, the nodes 26 of the wireless beacon tracking system 20 are operable for acquiring, or obtaining information regarding each of the computing devices 12 being displayed and protected by the system. The initial location of a tag 34 may be referred to herein as the “home location” HL. In one embodiment, each tag 34 may be configured to transmit a “ping” or pulse signal that is detectable by one or more of the nodes 26. The tag 34 may be configured to transmit a ping signal in predetermined increments of time (e.g., once about every one second). In some cases, ultra-wideband communication may be employed. The server 30 may be configured to receive data from the nodes 26 which is used to determine a location of the tag 34, such as using time of flight, time distance on arrival, and/or triangulation techniques. Data from one or more nodes 26 (e.g., signal strength, the time the signal is received, etc.) may be used to calculate the location of the tag 34. In another example, if a node 26 receives a signal from a tag 34 within an expected time frame, no alarm signal would be generated, but if no signal is received or the signal is outside of the expected time frame, an alarm signal may be generated.

In one embodiment, the tags 34 may be configured to be removed by an authorized person without initiating an alarm signal. For instance, tags 34 may be allowed to be removed in one or more “safe zones”, which may be designated locations where a sales associate may remove a tag. Because the location of the tags 34 may be tracked, the location of the tag relative to the safe zone when removed from the computing device 12 may be indicative of whether an authorized removal occurred. If the tag 34 is removed within a safe zone, it can be safely assumed that the tag was removed by an authorized sales associate. If, however, the tag 34 is removed outside of a safe zone, then an alarm signal may be initiated. In some cases, the tag 34 may be configured to communicate with a key for removing the tags, such as via the exchange of a security code. In other cases, the sales associate may use a key to communicate with an authorized device while the tag 34 is in close proximity to the authorized device to signify that the tag is being removed by an authorized sales associate. The authorized device could be located within a safe zone.

In one embodiment, the computing devices 12 and/or tags 34 may utilize Wi-Fi communication to communicate a MAC address to the nodes 26 for determining a location of the tags. The initial location of a tag 34 may be determined by triangulating the MAC address of the address from at least three (3) of the nodes 26. Thereafter, the nodes 26 may periodically obtain the MAC addresses of the computing devices 12 and/or tags 34, determine the updated locations of the devices 12, and upload the updated locations of the devices 12 to the server 30 and/or the remote device 28. In one embodiment, the wireless beacon tracking system utilized similar methodology as disclosed in U.S. Provisional Application No. 62/198,163, entitled Wireless Beacon Tracking System for Merchandise Security, and filed on Jul. 29, 2015, the contents of which are incorporated by reference in its entirety herein.

In some embodiments, the server 30 may communicate with remote devices 28 to notify the sales associate when a wireless-enabled computing device 12 has been lifted from a display surface 24 by a customer to be examined and/or operated. A customer lifting the device 12 can be indicated by detecting a vertical movement of the device 12 within a small horizontal distance to a new location relative to the home location HL. The server 30 may communicate with remote devices 28 to notify the sales associate that a customer may be examining and/or operating the wireless-enabled computing device 12 so that the sales associate can offer assistance to the customer. Alternatively, the server 30 and/or the remote device 28 may stream marketing information, such as a promotional video, to the wireless-enabled computing device 12 to assist the customer to evaluate the device.

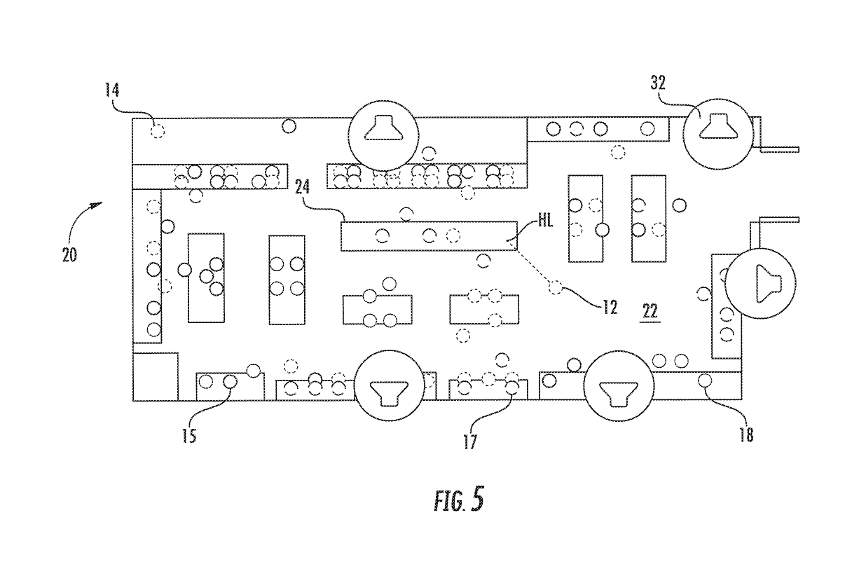

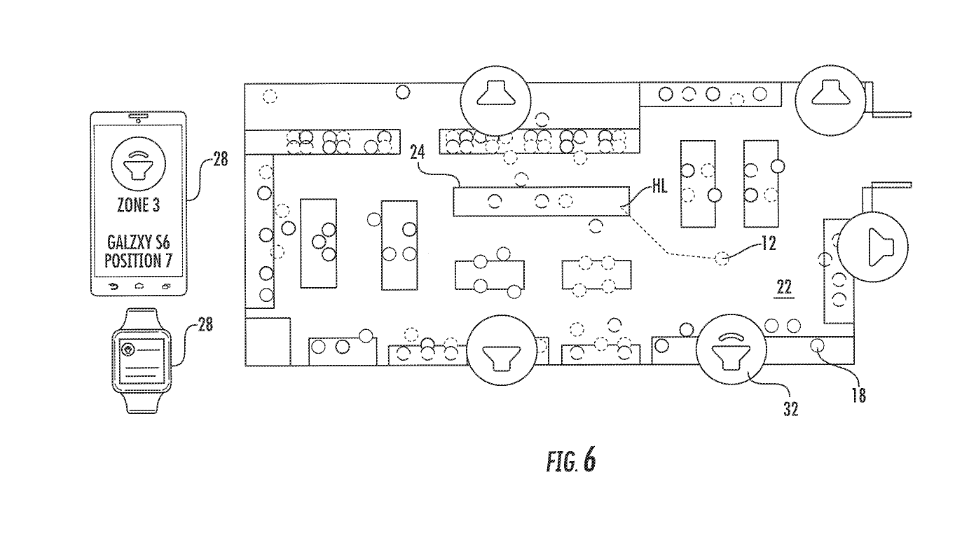

In another embodiment, the merchandise security system 10 may transmit a message to the wireless-enabled computing device 12 to warn a customer that the device has been moved beyond a predetermined distance from the home location HL. By way of example and not limitation, the server 30 and/or remote device 28 may transmit a visual and/or audible alarm signal to the wireless-enabled computing device 12, or to another component of the system, when the device 12 is moved beyond the predetermined distance from the home location HL. If desired, a series of messages, signal and/or alarms may be transmitted or initiated by the server 30 and/or any remote device 28 as the device 12 is moved farther from the home location HL. For example, the server 30 and/or remote device 28 may transmit or initiate an audio warning message instructing the customer to return the wireless-enabled computing device 12 to the home location HL. In the event the customer does not comply with the warning instruction, the server 30 and/or remote device 28 may transmit or initiate a visual and/or audible alarm signal. In addition, where a sales associate, security officer, or other store personnel is provided with one or more remote devices 28 (e.g., a mobile telephone or other communications device), the remote device may be notified, for example, by receiving a text message (see, e.g., FIG. 6, where the remote device receives a text message indicating a specific zone, device, and position). Moreover, FIG. 5 shows that one or more annunciators 32 may be located at various desired locations about the display area 22 (e.g., at one or more exit points within the display area). One or more of the annunciators 32 may be in communication with the server 30 and/or remote devices 28 to provide an audio and/or a visual notification based on a location of the wireless-enabled computing device 12.

FIGS. 5-9 illustrate a sequence of movements of a wireless-enabled computing device 12 from a home location HL as determined by the wireless beacon tracking system 20 of the merchandise security system 10. FIG. 6 shows the device 12 has been moved a distance greater than a predetermined allowable distance from the home location HL. As a result, the server 30 may provide a message to a remote device 28 associated with a sales associate, referred to herein as an “Associate Notification.” The Associate Notification may, for example, include identification of the wireless-enabled computing device 12 (e.g., “Galaxy S6” in FIGS. 5-9) and the home location HL (e.g., “Position 7” in FIGS. 5-8) of the device. The Associate Notification may also include an identification of a zone (e.g., “Zone 3” in FIG. 6) of the display area 22 in which the location of the wireless-enabled computing device 12 was last determined. As shown in FIGS. 6-9, the Associate Notification may change or be updated in response to movement of the wireless-enabled computing device 12 within the display area 22.

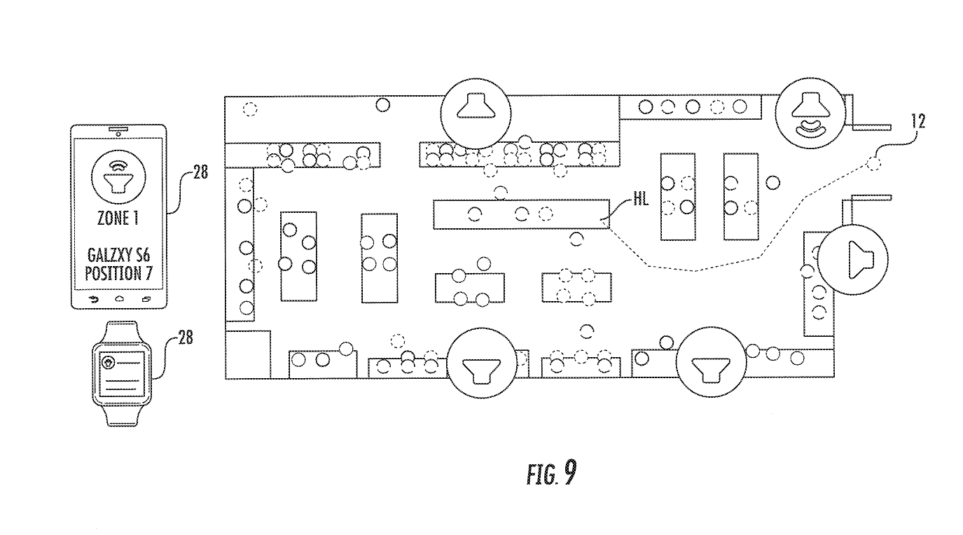

The Associate Notification may also be color-coded to indicate the distance of the device 12 from the home location HL. By way of example and not limitation, the sales associate may receive a symbol or image colored green to indicate that the device 12 is located within a predetermined allowable distance from the home location HL. As illustrated by FIGS. 6-8, the symbol or image may change or be colored yellow to indicate that the device 12 has been moved to a location that is a greater distance from the home location HL than the allowable distance, but less than an unacceptable distance that suggests an attempted theft of the device. Furthermore, as illustrated by FIG. 9, the symbol or image may change or be colored red to indicate that the device 12 is located at a distance from the home location HL that is greater than the unacceptable distance. When the wireless-enabled computing device 12 is moved to a location that is greater than the unacceptable distance from the home location HL, the Associate Notification may be replaced by an Associate Alarm. In addition, a visual and/or audible alarm may be activated within the display area 22 and/or the retail store, such as via one or more annunciators 32. For instance, FIGS. 6-8 show that a selected annunciator nearest to the device 12 may be activated in response to movement of the device.

In yet another embodiment, a merchandise security system 10 according to the present invention may utilize a wireless beacon tracking system 20 that is configured to acquire, or obtain, a MAC address of a wireless-enabled computing device, such as a mobile telephone, belonging to a customer. The nodes 26 of the wireless beacon tracking system 20 may periodically detect the MAC address of the customer's mobile telephone and determine the location of the customer's mobile telephone within the retail store by means of triangulation using at least three (3) of the nodes. The location(s) of the customer's mobile telephone may be used to determine which product(s) the customer spent an appreciable amount of time examining and/or operating. The information may also be used to determine whether a customer returned to examine and/or operate a particular product. In the event that a customer remains at the home location HL of a particular product for a predetermined period of time, the merchandise security system 10 could send the customer a special offer or coupon to persuade the customer to purchase the product.

A merchandise security system 10 according to another embodiment of the present invention may utilize a wireless beacon tracking system 20 as previously described to store the MAC address and track the location of a potential thief. By way of example and not limitation, the merchandise security system 10 could determine whether a wireless-enabled computing device 12 that is a display device having a known MAC address registered with the server 30 and/or the remote device 28 left the display area 22 and/or the retail store with a wireless-enabled computing device, such as a mobile telephone, having a MAC address that is not registered with the server 30 and/or remote device 28. The MAC address of the device that is not registered with the server 30 and/or remote device 28 can then be provided to security personnel, local police or other law enforcement agency to locate and apprehend the thief using local Wi-Fi hotspots.

In one embodiment, the wireless beacon tracking system 20 is similar to the NAVIZON® Indoor Triangulation System (ITS) commercially available from Navizon, Inc. OF Miami, Fla., USA. The NAVIZON® ITS is a real-time locating system (RTLS) designed for tracking active Wi-Fi-enabled devices inside buildings or throughout a campus environment. The NAVIZON® ITS determines in real-time the location of active wireless-enabled devices and tracks movements of the devices over time. Presently, the NAVIZON® ITS RTLS is capable of detecting at least iPhone®, iPad®, Android, Blackberry®, Windows Mobile, Symbian, and Wi-Fi tags. The NAVIZON® ITS system includes a plurality of hardware nodes that are deployed at known locations throughout a monitored area, and a cloud-based server that runs on a private network cloud or a public cloud. The nodes detect active Wi-Fi devices and periodically upload a list of MAC addresses and signal strengths to the cloud-based server. The server then estimates the locations of the Wi-Fi devices relative to the nodes.

According to another embodiment, the wireless beacon tracking system 20 may utilize light-based technology (e.g., Visible Light Communication (VLC)) to determine a location of a computing device relative to a home location. The light-based technology may be used in lieu of or in addition to the Wi-Fi based embodiments discussed above. For instance, the wireless beacon tracking system 20 may include an LED system that is configured to communicate with one or more computing devices. The LED system may be configured to illuminate an area using a uniquely coded light signal that is referenced to a map diagram lookup table, which may be used to correlate a particular group of LEDs that are at a known location. The computing device may be configured to detect the uniquely coded light signals generated by the LEDs such as via the computing device's camera. The computing device may include a software application for facilitating the communication with its camera and interpreting the light signals. The computing device may be further configured to communicate the awareness of its location, such as via Wi-Fi communication, to another device such as a server or other monitoring device. Therefore, VLC technology may be used to determine and track the location of computing devices relative to a home location.

A wireless tracking security system 10′ and method according to another embodiment of the invention are operable for use with portable computing devices, such as portable computing devices associated with customers within a commercial establishment, such as a retail store. In some embodiments, the wireless tracking system 10′ is provided for displaying portable computing devices 12′ and protecting the computing devices from theft. In one embodiment the wireless tracking system 10′ tracks the position of each of the computing devices 12′ and/or determines various information associated with the computing devices 12′.

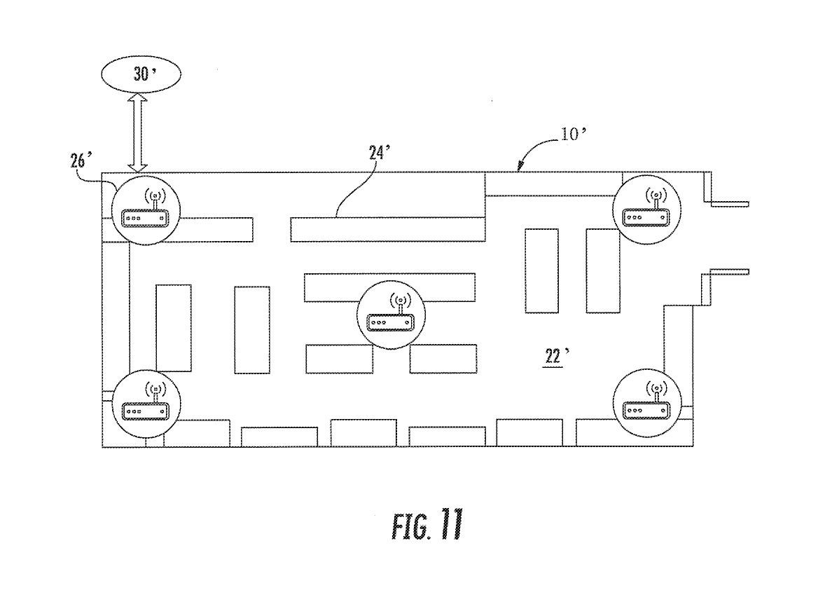

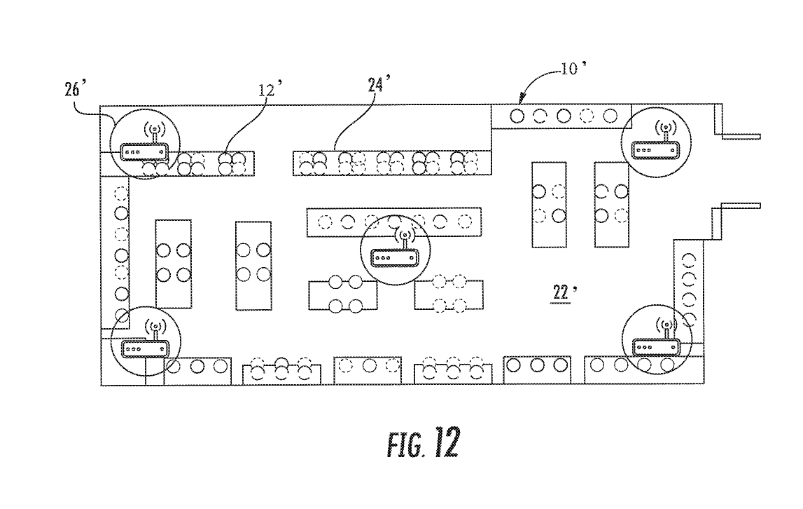

FIGS. 11-13 illustrate exemplary embodiments of a wireless tracking system 10′ according to the present invention. FIG. 12 illustrates a wireless tracking system 10′ according to an embodiment of the present invention provided in an open display area 22′, such as a merchandise display area of a retail store, for displaying and locating wireless-enabled computing devices 12′. As referred to in this embodiment, the term “open” is intended to mean that a customer may move about within the display area 22′ without passing through a security checkpoint or gateway that generates an alarm signal. The wireless tracking system 10′ may include a custom floor plan in a retail environment. The display area 22′ may include a number of display surfaces 24′, such as a table, shelf, countertop, stand, base, or the like, for supporting one or more wireless-enabled computing devices 12′. Typically, several wireless-enabled computing devices 12′ of the same type or different types are supported on each display surface 24′. The wireless-enabled computing devices 12′ may be supported on a display surface 24′ without the device being attached or tethered to a merchandise security device. As a result, a customer may examine and freely interact with the wireless-enabled computing device 12′ in a manner that enhances the customer experience, and thereby increases the likelihood that the customer will make a decision to purchase the device. Typically, the customer purchases the wireless-enabled computing device 12′ from the inventory of the retailer with the assistance of a sales associate. However, it is understood that each of the computing devices 12′ may be tethered to the display surface 24′ or security device in other embodiments. Moreover, it is understood that the computing devices 12′ may be the customers' own devices in some embodiments.

In one embodiment, the wireless tracking system 10′ comprises one or more nodes 26′ that are positioned at predetermined locations within the display area 22′. By way of example and not limitation, at least three nodes 26′ may be provided. Regardless, each node 26′ is operable for detecting one or more active wireless-enabled computing devices 12′, and for periodically obtaining a unique identifier of the computing device and/or a signal strength of each of the devices detected by the node(s). In some cases, the unique identifier is a MAC address and the signal strength may be a strength of a Wi-Fi signal, although other wireless signals may be used for this purpose (e.g., Bluetooth, Bluetooth low energy, WiFi, Near Field Communication (“NFC”), cellular, received signal strength indicator (“RSSI”), ultra-wideband (“UWB”) and/or ambient backscatter). The wireless tracking system 10′ may further comprise a server 33′ operable for communicating with each of the nodes 26′ to determine the location of a wireless-enabled computing device 12′ relative to the nodes. By way of example and not limitation, the server 30′ may determine the location of the wireless-enabled computing device 12′ by means of triangulation utilizing at some of the nodes 26′. In some cases, the server 30′ may be a cloud-based server on a public or private network for receiving and analyzing various information received from the nodes 26′.

FIG. 12 shows a plurality of wireless-enabled computing devices 12′, which may be located on display surfaces 24′ within an open display area 22′ of a retail store or associated with one or more customers within the display area. The wireless-enabled computing devices 12′ may be located at positions recognized by one or more nodes 26′. At least some of the wireless-enabled computing devices 12′ may not be attached or tethered to a merchandise security device, such as an alarming merchandise security stand. In some cases, each of the wireless-enabled computing devices 12′ may comprise an internal network adapter having a MAC address. As previously described, the wireless tracking system 10′ comprises a plurality of nodes 26′ positioned within the display area 22′, which may be in a predetermined pattern or location. In one embodiment, nodes 26′ may be able to communicate with other nodes to determine the location of one or more computing devices 12′. For example, one node 26′ may receive signals from each of the other nodes and determine the nodes with the strongest detected signal strength of the computing device 12′ (e.g., two other nodes with the strongest detected signal strength). Using the nodes 26′ detecting the strongest signal strength of the device 12′, the server 30′ can receive this information for determining the position of the device. In some cases, the position of the devices 12′ may be tracked in real time. One or more of the nodes 26′ may communicate directly with the server 30′ and/or one or more remote devices 28′ for providing information regarding one or more computing devices 12′. Each node 26′ may be located at any desired location within the wireless tracking system 10′ where an authorized user or administrator can manage and track the computing devices 12′. In one embodiment, the server 30′ may include software that enables an authorized user to visually track the location of the computing devices 12′, such as on a map, which may occur in real time.

Some of the wireless-enabled computing devices 12′ may be registered with a server 30′, such as a cloud-based server on a public or private network. For example, for each computing device 12′ on display in the display area, the MAC address will be known and can be registered at a central location with the server 30′. In one embodiment, the server 30′ may be a central control device on a local area network. However, in other cases, such as a customer's computing device 12′, the computing device may be unknown until detected by the wireless tracking system 10′. The wireless tracking system 10′ may be configured to obtain the unique identifier (e.g., MAC address) of the customer's computing device 12′ and record the identifier, which may occur automatically or in response to some event (e.g., a security event). In some embodiments, a security event may be a theft event, such as where an item of merchandise or a computing device 12′ is stolen and/or an alarm signal is activated. Thus, should the customer with a stolen computing device 12′ or a computing device in the proximity of a security event return to the store, the identifier of the customer's computing device 12′ that matches the recorded identifier may be detected so that the retailer can be warned or an alarm signal may be generated. In addition, retailers may choose to share information or provide notifications to other stores when a security event occurs. For instance, a unique identifier associated with a security event may be broadcasted to other retailers or stores so that the identifier may be monitored at these other locations.

The remove device 28′ may, for example, be a personal computer, such as a desktop, laptop, tablet or notebook computer, a mobile telephone, such as a Smartphone, or a wearable wireless device. In some embodiments, the server 30′ may communicate with one or more remote devices 28′. Each remote device 28′ may be located at any desired location, such as remote from the wireless tracking system 10′ where an authorized user or administrator can manage and track the wireless-enabled computing devices 12′. In some cases, the user may log into an administrative online dashboard and define various levels of the location of the wireless-enabled computing devices 12′, upload floor plans or a map for each level, and/or mark the placement of each node on the floor plan or map of each level. In other cases, remote devices 28′ may be provided to sales associates located within or near the display area 22′ for receiving various notifications and information from the server 30′ and/or other remote devices.

The nodes 26′ of the wireless tracking system 10′ are operable for acquiring, or obtaining, the MAC address and/or other unique identifier of each of the wireless-enabled computing devices 12′ in the display area 22′. The location of each of the wireless-enabled computing devices 12′ may be determined by triangulating the MAC address of the computing device from at least three (3) of the nodes 26′. Thereafter, the nodes 26′ may periodically obtain the MAC addresses of the wireless-enabled computing devices 12′, determine the updated locations of the devices 12′, and upload the updated locations of the devices 12′ to the server 30′ and/or the remote device 28′. In some cases, the initial location, also referred to herein as the “home location” HL, of the computing devices 12′ may be determined. In the event that a device 12′ has moved from the home location, the server 30′, the nodes 26′, and/or the remote device 28′ may provide a suitable output to an administrator of the wireless tracking system 10′, for example a sales associate assigned to the display area 22′.

In one embodiment, the nodes 26′ may be security devices 15′ located within the display area 22′ and/or computing devices 12′ that are on display in the display area. For example, the security devices 15′ may be similar to that provided by InVue Security Products Inc. and may include a sensor attached to an item of merchandise and/or a base configured to support the item of merchandise. The security devices 15′ may be configured to detect and generate an alarm signal in response to a security event, such as unauthorized removal of the computing device from the security device. In this embodiment, the security devices 15′ may be configured to communicate with the computing devices 12′ in the same way as the nodes 26′. Similarly, the computing devices 12′ attached to the security devices 15′ may also function as nodes 26′ in some embodiments. In this case, the computing devices 12′ secured by the security devices 15′ may be configured to communicate with customers' computing devices for tracking the customers' devices. Moreover, the wireless tracking system 10′ may be used to facilitate planogram compliance of computing devices 12′ on display. In some cases, the wireless tracking system 10′ may provide location data of the computing devices 12′ on display over a period of time so that the location of the computing devices relative to one another can be determined.

In some embodiments, the server 30′ may communicate with remote devices 28′ to notify a sales associate when a wireless-enabled computing device 12′ has been lifted from a display surface 24′ by a customer to be examined and/or operated. A customer lifting the device 12′ can be indicated by detecting a vertical movement of the device 12′ within a small horizontal distance to a new location relative to the home location HL. The server 30′ may communicate with remote devices 28′ to notify the sales associate that a customer may be examining and/or operating the wireless-enabled computing device 12′ or that a customer's computing device is in a particular location so that the sales associate can offer assistance to the customer. Alternatively, the server 30′ and/or the remote device 28′ may stream marketing information, such as a promotional video, loyalty programs, or discounts, to the wireless-enabled computing device 12′ to assist or lure the customer in deciding whether to purchase a product. In addition, the retailer may provide various marketing information to the computing device 12′ if the wireless tracking system 10′ detects that the customer has returned to a particular location more than one time. The retailer may take advantage of various promotions and advertisements for customers, including returning customers, and generate revenue based on successful click-through's.

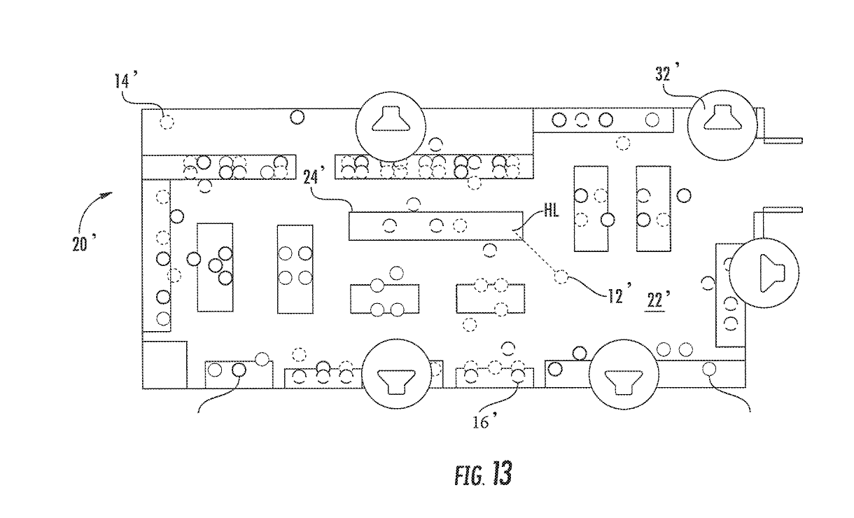

In another embodiment, the wireless tracking system 10′ may transmit a message to the wireless-enabled computing device 12′ to warn a customer that the device has been moved beyond a predetermined distance from the home location HL. By way of example and not limitation, the server 30′ and/or remote device 28′ may transmit a visual and/or audible alarm signal to the wireless-enabled computing device 12′, or to another component of the system, when the device 12′ is moved beyond the predetermined distance from the home location HL. If desired, a series of messages, signal and/or alarms may be transmitted or initiated by the server 30′ and/or any remote device 28′ as the device 12′ is moved farther from the home location HL. For example, the server 30′ and/or remote device 28′ may transmit or initiate an audio warning message instructing the customer to return the wireless-enabled computing device 12′ to the home location HL. In the event the customer does not comply with the warning instruction, the server 30′ and/or remote device 28′ may transmit or initiate a visual and/or audible alarm signal. In addition, where a sales associate, security officer, or other store personnel is provided with one or more remote devices 28′ (e.g., a mobile telephone or other communications device), the remote device may be notified, for example, by receiving a text message (e.g., where the remote device receives a text message indicating a specific zone, device, and position). Moreover, FIG. 13 shows that one or more annunciators 32′ may be located at various desired locations about the display area 22′ (e.g., at one or more exit points within the display area). One or more of the annunciators 32′ may be in communication with the server 30′ and/or remote devices 28′ to provide an audio and/or a visual notification based on a location of the wireless-enabled computing device 12′. In addition, a visual and/or audible alarm may be activated within the display area 22′ and/or the retail store, such as via one or more annunciators 32′. For instance, a selected annunciator 32′ nearest to the computing device 12′ may be activated in response to computing device being within a predetermined distance or range from the annunciator or some specified location.

As discussed above, a wireless tracking system 10′ according to the present invention may be configured to acquire, or obtain, a MAC address of a wireless-enabled computing device 12′, such as a mobile telephone, belonging to a customer. The nodes 26′ of the wireless tracking system 10′ may periodically detect the MAC address of the customer's mobile telephone and determine the location of the customer's mobile telephone within the retail store by means of triangulation using at least three (3) of the nodes. The location(s) of the customer's mobile telephone may be used to determine which product(s) the customer spent an appreciable amount of time examining and/or operating. The information may also be used to determine whether a customer returned to examine and/or operate a particular product. In the event that a customer remains at the home location HL of a particular product or some other designated location for a predetermined period of time, the wireless tracking system 10′ could send the customer a special offer or coupon to persuade the customer to purchase the product. The wireless tracking system 10′ may be configured to track the number of customers entering a store and facilitate collection of various data and patterns to assist the retailer in making business decisions. For example, the wireless tracking system 10′ could be used to notify the retailer in the event of a surge in a number of customers or in the event that an abnormal number of customers is in the store or at a particular location. In addition, the wireless tracking system 10′ could be used to notify the retailer of any abnormalities regarding computing devices 12′ entering a store, at a particular location, or experiencing a security event.

A wireless tracking system 10′ according to another embodiment of the present invention may be configured to identify and/or store the MAC address and track the location of a potential thief. By way of example and not limitation, the wireless tracking system 10′ could determine whether a wireless-enabled computing device 12′ that is a display device having a known MAC address registered with the server 30′ and/or the remote device 28′ left the display area 22′ and/or the retail store with another wireless-enabled computing device, such as a mobile telephone, having a MAC address that is not registered with the server 30′ and/or remote device 28′. The MAC address of the computing device 12′ that is not registered with the server 30′ and/or remote device 28′ can then be provided to security personnel, local police or other law enforcement agency to locate and apprehend the thief using local Wi-Fi hotspots.

As noted above, embodiments of the present invention are adaptable to a variety of industries and potential uses. In one embodiment, a wireless tracking system 10′ may be used to identifying traffic patterns for various planning purposes. For example, users of wireless-enabled computing devices 12′ may be associated with vehicles and used for identifying crowd or traffic patterns. City planners could utilize such a tracking system 10′ to identify patterns by analyzing location data from computing devices 12′ for improving traffic flow and reducing congestion, such as by diverting traffic, adding/removing stop signs or lights, etc. Nodes 26′ could be positioned at various locations, or computing devices 12′ may communicate with one another, to detect a MAC address and to determine a location of each computing device. Furthermore, similar data may be used to improve traffic flow among crowds, such as at an amusement park. For instance, computing devices 12′ at the amusement park may be located and used to collect data indicative of crowd patterns at particular locations and times. And users of the computing devices 12′ could be notified of such crowd patterns in an attempt to avoid large crowds, while the operator of the amusement park may use the data to improve crowd flow to avoid bottlenecks.

In yet another embodiment, a wireless tracking system 10′ may include a network (e.g., Internet of Things (IoT) technology). For example, various residential or commercial security devices (e.g., a camera, doorbell, locks, etc.) may function similarly to, or include, a node 26′ and be configured to communicate with a computing device 12′. Thus, the nodes 26′ may detect a MAC address associated with a computing device 12′ that is in proximity thereto and identify and/or record the address. If a security event occurs, local authorities may use the MAC address detected near or at the location of the security event to aid in locating the computing device 12′ associated with the MAC address. The nodes 26′ could also provide warnings to other nearby nodes or computing devices 12′. Moreover, the network of nodes 26′ could be expanded to, for example, a plurality of homes or buildings, such that the nodes may be used for reporting a MAC address associated with a computing device 12′ based on a security event or other suspicious activity. For instance, where a particular MAC address is regularly detected at particular times or locations, warnings may be provided to residents in the vicinity of the MAC address. It is understood that the aforementioned wireless tracking system 10′ could be used to track any number of objects, including but not limited to, pets, children, etc.

The foregoing has described one or more embodiments of a merchandise security system and method for displaying an item of merchandise and for protecting the item of merchandise from theft that utilize a wireless beacon tracking system. Embodiments of a merchandise security system and method have been shown and described herein for purposes of illustrating and enabling the best mode of the invention. Those of ordinary skill in the art, however, will readily understand and appreciate that numerous variations and modifications of the invention may be made without departing from the spirit and intended broad scope of the invention. Accordingly, all such variations and modifications are intended to be encompassed by the appended claims.

That which is claimed is:

1. A wireless tracking system for tracking wireless-enabled computing devices, the wireless tracking system comprising:
at least one wireless-enabled computing device having a unique media access control (MAC) address; and
a wireless tracking system comprising a plurality of nodes positioned within a display area, the plurality of nodes configured to obtain the MAC address of the wireless-enabled computing device for determining a location of the wireless-enabled computing device, the wireless tracking system further comprising a server operably associated with the plurality of nodes for tracking the location of the wireless-enabled computing device.

2. The wireless tracking system of claim 1, wherein the plurality of nodes comprises at least three nodes.

3. The wireless tracking system of claim 1, wherein the plurality of nodes comprises wireless-enabled computing devices.

4. The wireless tracking system of claim 1, wherein the plurality of nodes comprises security devices.

5. The wireless tracking system of claim 1, wherein the server is configured to record the MAC address.

6. The wireless tracking system of claim 1, further comprising a plurality of wireless-enabled computing devices, wherein the plurality of nodes are configured to obtain the MAC address of each of the plurality of wireless-enabled computing devices.

7. The wireless tracking system of claim 1, wherein the at least one wireless-enabled computing device comprises an active mobile telephone.

8. The wireless tracking system of claim 1, wherein the server is configured to initiate an alarm signal in response to a security event.

9. The wireless tracking system of claim 1, wherein the at least one wireless-enabled computing device is located at an initial home display location, and wherein the plurality of nodes are configured determine a location of the wireless-enabled computing device relative to its an initial home display location.

10. The wireless tracking system of claim 9, wherein the server is operable for actuating an alarm signal in response to the at least one wireless-enabled computing device being located at a distance from the initial display home location that is greater than a predetermined unacceptable distance.

11. The wireless tracking system of claim 1, wherein the server configured to register the MAC address of the at least one wireless-enabled computing device for associating the location with the wireless-enabled computing device.

12. The wireless tracking system of claim 1, wherein the plurality of nodes are positioned within the display area in a predetermined grid pattern.

13. A method for tracking wireless-enabled computing devices, the wireless-enabled computing devices each having a unique media access control (MAC) address, the method comprising:
obtaining a MAC address of at least one wireless-enabled computing device using a plurality of nodes positioned within a display area;
determining a location of the at least one wireless-enabled computing device; and
tracking the at least one wireless-enabled computing device using the location and the MAC address.

14. The method of claim 13, wherein determining a location of the wireless-enabled computing device comprises triangulating the plurality of nodes.

15. The method of claim 13, further comprising providing a notification relating to the location of the wireless-enabled computing device relative to a home location.

16. The method of claim 13, further comprising actuating an alarm signal in response to a security event.

17. The method of claim 13, wherein determining a MAC address comprises determining a MAC address of a wireless-enabled computing device belonging to a customer.

18. The method of claim 13, wherein determining a MAC address comprises determining a MAC address of a wireless-enabled computing device belonging to a potential thief.

19. The method of claim 13, wherein determining a MAC address comprises determining a MAC address of each of a plurality of wireless-enabled computing devices.

20. The method of claim 13, further comprising recording the MAC address.
